(19) United States
(12) Patent Application Publication
(10) Pub. No.: US 2021/0276903 A1
(43) Pub. Date: Sep. 9, 2021

(54) MEMBRANE AERATED SECONDARY CLARIFIER

(71) Applicant: FLUENCE WATER PRODUCTS AND INNOVATION LTD, Caesarea (IL)

(72) Inventors: Ronen-Itzhak SHECHTER, Kiryat Tivon (IL); Noam Mordechai SIEGEL, Tel-Aviv (IL)

(73) Assignee: FLUENCE WATER PRODUCTS AND INNOVATION LTD, Caesarea (IL)

(21) Appl. No.: 16/336,690

(22) PCT Filed: Sep. 25, 2017
(86) PCT No.: PCT/IL2017/051070

§ 371 Date: Mar. 26, 2019

Related U.S. Application Data
(60) Provisional application No. 62/399,699, filed on Sep. 26, 2016.

(51) Int. Cl. C02F 3/20; C02F 1/72; C02F 3/10

(52) U.S. Cl. CPC C02F 3/208; C02F 1/727; C02F 2001/007; C02F 3/201; C02F 3/205; C02F 3/102

(57) ABSTRACT

Provided is a clarifier unit of wastewater treatment system and a system comprising the unit, the unit including a treatment tank having a bottom wall, side walls, influent inlet, clarified water outlet and a sludge discharge outlet; wherein the unit has an oxygen supply assembly, including one or more oxygen supply elements confined to a bottom portion of the tank, each of which includes (i) a water-tight enclosure including oxygen-permeable membranes permitting oxygen permeation by, for example, a diffusion from the enclosure to a surrounding medium, and (ii) a gas inlet for receiving an oxygen-containing gas and a gas outlet for removal of gas.

### TECHNOLOGICAL FIELD

This disclosure concerns a unit and system for the treatment of water rich in biological mass, particularly wastewater or other water being treated. The unit of this disclosure is typically used as a secondary clarifier in a wastewater treatment system.

### BACKGROUND ART

References considered to be relevant as background to the presently disclosed subject matter are listed below:
WO 2016/108227
WO 2016/038606

Acknowledgement of the above references herein is not to be inferred as meaning that these are in any way relevant to the patentability of the presently disclosed subject matter.

### BACKGROUND

Secondary clarifiers are essential components in many of the biological wastewater treatment systems. Mixed liquor from a secondary treatment bioreactor flows to a secondary clarifier. The mixed liquor is comprised of water and suspended solids. In the secondary clarifier solids settle to the bottom and clarified treated water is discharged from an effluent outlet at the top of the clarifier. Sludge outlet at the bottom of the clarifier is used to remove excess of accumulated sludge, transfer to recycle line and return to the secondary treatment, or the sludge is disposed via a sludge disposal outlet conduit. Thus, the liquid medium in the clarifier has a gradient of solids concentrations resulting from the gravitational settling of solids: the top phase of the medium comprises the clarified water (effluent), while at the bottom, a volume of settled thickened sludge is formed, typically referred to as a “sludge blanket”.

Mixed liquor from a secondary treatment bioreactor often contains a residual concentration of dissolved nitrogen oxides, such as nitrates. During sludge retention at the bottom part of the secondary clarifier, a portion of the sludge undergoes hydrolysis and breaks down into organic matter that biodegrades by heterotrophic bacteria, or there might be residual organic matter left after treatment that biodegrades by heterotrophic bacteria. In the absence of oxygen, bacteria oxidize the organic matter using nitrogen oxides, such as nitrate, as electron acceptors instead of oxygen, producing nitrogen by the following denitrification reaction:

2NO₃⁻+10e⁻+12H⁺→N₂+6H₂O

In this reaction, the electron (e−) donor is the biodegradable organic matter remaining after treatment or resulting from hydrolysis of sludge; and the nitrate (NO₃⁻) is typically produced in the secondary treatment bioreactor during biological nitrification of ammonium compounds.

During the denitrification reaction, gaseous nitrogen (N₂) is produced. Due to the limited solubility of nitrogen in water, it tends to form bubbles that rise in the aqueous medium and release to the atmosphere upon reaching the surface. During the process, bubbles attach to particles of suspended solids in the sludge and cause floatation and accumulation of the solids on the surface of the water. These floating solids, also known as “scum”, may deteriorate the effluent quality and may cause a variety of operational issues.

The maintenance of a low sludge blanket is a measure routinely used the minimize scum. Other operational means to overcome scum is to minimize residual nitrate concentration. These measures have a variety of shortcomings and apply unnecessary constraints that have undesired operational and cost considerations.

### General Description

The present disclosure element is based on the realization that in the process of clarifying mixed liquor from a biological wastewater treatment process in a water clarifier unit, particularly a secondary clarifier, the biological degradation of sludge from a bottom portion of the clarifier, particularly in the sludge blanket, should advantageously be accompanied by feeding oxygen in a bubbles-free manner. The feeding of oxygen prevents biomass at the sludge blanket from performing denitrification which, if occurring, releases nitrogen gas to the aqueous medium (i.e. the water that is being treated), thus causing floatation of solids and reducing the quality of the effluent.

Oxygen feeding is achieved, according to this disclosure, by the use of oxygen supply element placed in and confined to a bottom portion of a treatment tank, typically at the level of or least partially within the sludge blanket and that can release oxygen into the surrounding aqueous medium in a bubbles-free manner. The oxygen supply elements have each a water-tight enclosure, at least a portion of the walls of the enclosure comprise an oxygen permeable membrane that permit oxygen permeation e.g. by diffusion from within the enclosure to the surrounding aqueous medium. The term “membrane”, as used herein, refers to a pliable sheet-like structure acting as a boundary/partition/barrier that separates two spaces or media and in the context disclosed herein, has a selective permeability, such that it is permeable to and allows permeation, e.g. diffusion therethrough of gas while being impermeable to liquid, such as water. The oxygen supply element comprises a gas inlet for introducing an oxygen-containing gas into the enclosure and that is linked to and in gas communication with a source of an oxygen-containing gas; and a gas outlet for discharging gas out of the enclosure. The oxygen supplied to the enclosure permeates by diffusion through the oxygen-permeable membranes to the surrounding medium (which is the water being treated), enriching the medium with oxygen in a bubbles-free manner.

Thus, provided by one aspect of this disclosure is a clarifier unit that can form part of a wastewater treatment system. Provided by another aspect of this disclosure is a wastewater treatment system comprising such a clarifier unit. The unit of this disclosure is typically used as a secondary clarifier in a wastewater treatment system.

Provided by yet another aspect of this disclosure is a mechanical raking system for a secondary clarifier in a wastewater treatment plant, comprising oxygen supply elements of the kind specified above.

Provided by a further aspect of this disclosure is a system comprising oxygen supply elements of the kind specified for providing bubbles-free oxygenation in mechanical raking systems of secondary clarifiers in biological wastewater treatment plants.

The clarifier unit comprises a treatment tank defined by a bottom floor and side wall, a mixed liquor inlet for the introduction of such mixed liquor to be separated into the tank, a clarified water outlet (to be referred to herein as “effluent water outlet”) for egress of the treated effluent water (“clarified water”), and a sludge discharge outlet. The unit may further comprise a scraper or raking system adjacent the bottom wall of the tank for scraping sludge off the bottom wall and/or a conveyor for feeding the sludge to the sludge outlet. The floor of the clarifier is generally incline towards a sludge outlet zone.

The clarifier unit uniquely provided by this disclosure has an oxygen supply assembly that comprises a source of an oxygen-containing gas, one or more oxygen supply elements, of the kind specified above, confined to the bottom portion of the tank, and a conduit system with a gas-feeding conduit system for feeding the oxygen-containing gas from a gas source to the oxygen supply elements and a gas-outlet conduit system for discharging gas therefrom. Each of the oxygen supply elements has a gas inlet linked to a gas feed portion of the conduit system and a gas outlet linked to a gas discharge portion of the conduit system. At least a portion of the walls of the enclosure comprise an oxygen-permeable membrane, to thereby permit oxygen permeation by diffusion from the enclosure to the surrounding medium.

The oxygen-containing gas may be air, oxygen-rich gas such as air enriched with oxygen, or substantially pure oxygen. The source may comprise a gas fan, blower or pump for feeding the gas, particularly air, and/or a pressurized gas container. A Gas pump, a fan or a blower are typically the source where the oxygen-containing gas is air.

In use, an oxygen-containing gas is fed, through the gas feed, into the enclosure, through the gas inlet, from where oxygen diffuses out through the oxygen-permeable membrane into the surrounding aqueous medium.

In some embodiments, the unit includes one oxygen supply element. However, in some other embodiments, the unit typically comprises two or more such elements and the gas feed and gas outlet are, respectively, configured for feeding gas into and venting gas from the two or more oxygen permeable membrane elements.

The conduit system can, by one embodiment, be configured for parallel gas feeding and discharging from the two or more oxygen supply elements, in which case the gas-feeding conduit system and the gas outlet conduit system are each formed with a respective manifold arrangement for such parallel gas feeding and venting. The oxygen supply elements, by another embodiment, are arranged in series, whereby the outlet of one is connected to the inlet of another, etc. By yet another embodiment one or more groups of the oxygen-supply elements are arranged in series and the gas conduit system us configured for parallel gas feed and discharge from different groups. Thus, both parallel gas introduction and removal, a serial arrangement and a combined arrangement are contemplated according to different embodiments of this disclosure.

The at least one oxygen supply element is positioned within a space entirely below the level of the clarified water outlet. Particularly, the oxygen supply element is positioned within a space at the bottom half of the tank, typically at the bottom third or even at a bottom quarter of the tank. In some embodiments, the oxygen permeable membrane element are configured to be fully or partially embedded in the sludge blanket.

In some embodiments, the enclosure of the oxygen supply element is confined between two, opposite, water-impermeable and oxygen-permeable membranes that are usually essentially parallel to one another. The walls are typically made of a flexible or pliable film, which can be made of a polymeric material. Water impermeable and oxygen permeable membranes are known. Examples are membranes made of a fabric, typically a non-woven fabric, made of a polymeric material that is water and gas permeable, coated by a relatively thin water impermeable layer. The fabric can be a dense non-woven polyolefin fabric, e.g. a polyethylene or polypropylene-based fabric or one which is polyester-based. The coating is typically on the water-facing face of the membrane and can be made as alkyl-acrylate, compatible with a polyolefin fabric, or poly-methyl-pentene that is compatible with polyester.

In some embodiments, the enclosure of the oxygen supply element comprises one or more spacer elements between the two water-impermeable and oxygen-permeable membranes that typically play a structure-supporting role. This is particularly the case where the walls are pliable or flexible membranes. As can be appreciated, the inclusion of the spacer elements allows the pressure of gas introduced into the enclosure to be lower than the hydrostatic pressure of the water in which it is submerged. The spacer elements may also assist in distributing the gas flowing from the inlet to the outlet throughout the entire enclosure.

The oxygen supply elements are typically generally thin elements where the two, substantially parallel, opposite walls have a small gap therebetween, defining the enclosure's thickness. Examples are oxygen supply elements configured as planar plates or such configured as long sleeves arranged to define straight or curved paths including spirally-wound gas paths.

In some embodiments, the thin oxygen supply elements are arranged so that two opposite and parallel walls are essentially vertically oriented (namely, they may be vertically in some embodiments while being tilted off vertical in some other embodiments).

By some embodiments, the oxygen supply elements are configured as elongated sleeves, generally of a similar overall configuration to the sleeve disclosed in WO 2016/038606, but, as noted above, confined to a bottom portion of the tank. This sleeve may, by one embodiment, be arranged to define a generally circular path, examples being a closed circular or spiral path. The unit, for example, comprises a plurality of concentric oxygen supply elements. By another example, it comprises one or more spirally arranged oxygen supply element.

As noted above, the unit can also comprise a scraper or a conveyer for conveying the sludge to the sludge outlet. The one or more oxygen supply elements can be positioned above but in close proximity to such scraper or conveyer. By some embodiments, the oxygen supply elements are integrally formed with the scraper or conveyor. By one embodiment the unit comprises a plurality of oxygen supply element plates that are arranged to form a revolving array and these plates can also serve the function of scraping blades or guiding vanes.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1E are schematic illustrations of an exemplary embodiment of a clarifier unit of this disclosure, comprising a plurality of planar oxygen supply elements that revolve within a bottom portion of a clarifier tank. In these Figures:

FIG. 1A is an upper perspective view of a clarifier unit;

FIG. 1B is an upper perspective cross-sectional view of the unit of FIG. 1A, with the walls drawn partially transparent to permit the illustration of some internal elements;

FIG. 1C shows, in isolation, a revolving assembly of the unit including a plurality of oxygen supply elements fitted on two radial arms at its bottom end;

FIG. 1D shows an enlarged portion of the revolving assembly illustrating more details of the plurality of oxygen supply elements and of the gas feed and drain, with the orientation of the plates versus the arms on which they are fitted being slighted altered to illustrate an alternative orientation to that shown in FIG. 1C; and

FIG. 1E shows a single oxygen supply element unit in isolation.

FIGS. 2A-2F are schematic illustrations of an exemplary embodiment of a clarifier unit of this disclosure having a stationary oxygen supply element assembly, constituted by a plurality of concentric sleeves, fixed at the bottom portion of the clarifier tank. In these Figures:

FIG. 2A is a top perspective view of the unit;

FIG. 2B is a top perspective cross-sectional view with side walls drawn partially transparent to permit the illustration of some internal elements;

FIG. 2C shows a side view of the stationary oxygen supply element assembly and the scraper below it, in isolation;

FIG. 2D is a top perspective view of the stationary oxygen supply element assembly;

FIG. 2E is a side perspective view of one of the circular oxygen supply elements; and

FIG. 2F is an enlargement of portion of FIG. 2E.

### DETAILED DESCRIPTION OF EMBODIMENTS

In the following description, the invention will be illustrated with reference to the two specific embodiments, illustrated in the annexed Figures.

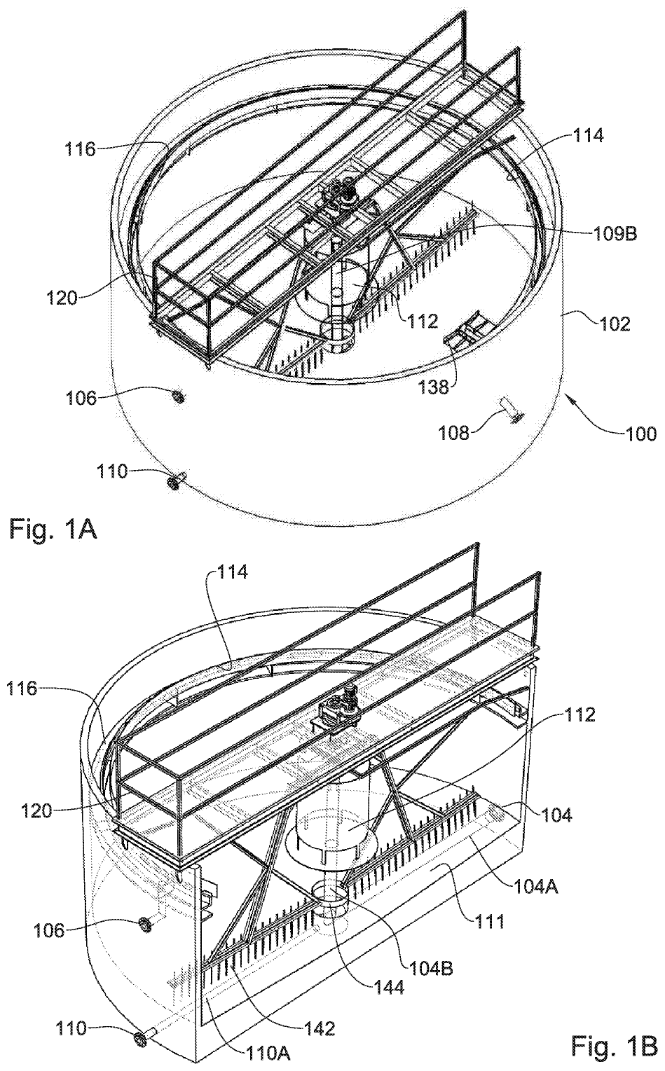

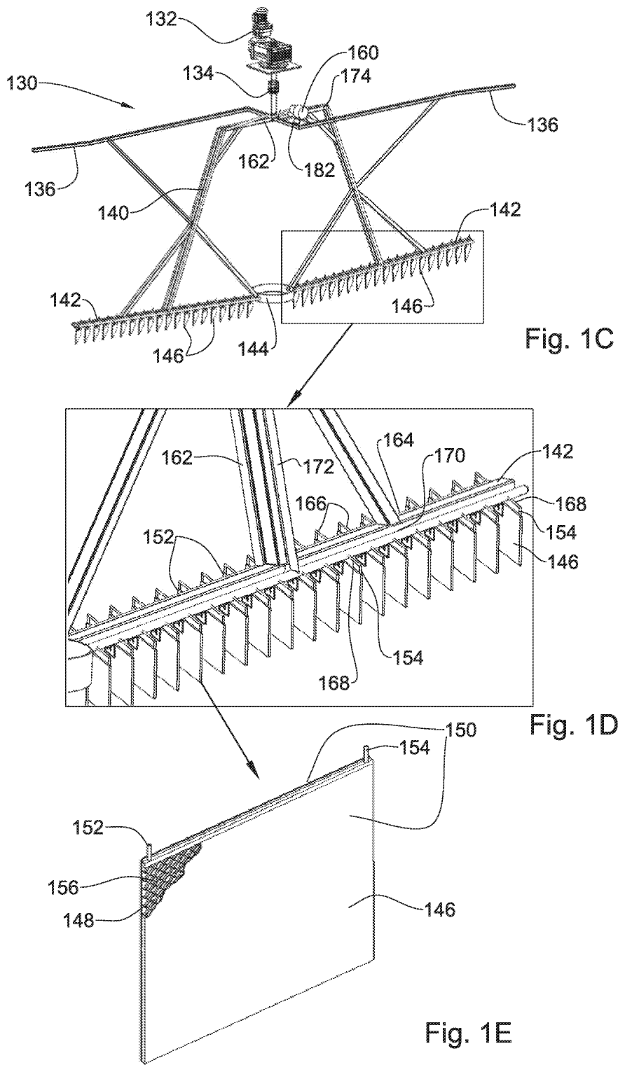

In accordance with one of these embodiments, illustrated schematically in FIGS. 1A-1E, a plurality of oxygen-supply elements are fixed on radial arms and at a bottom portion of the treatment tank that revolve in an essentially horizontal plane thereby diffusing oxygen throughout the bottom portion of the tank.

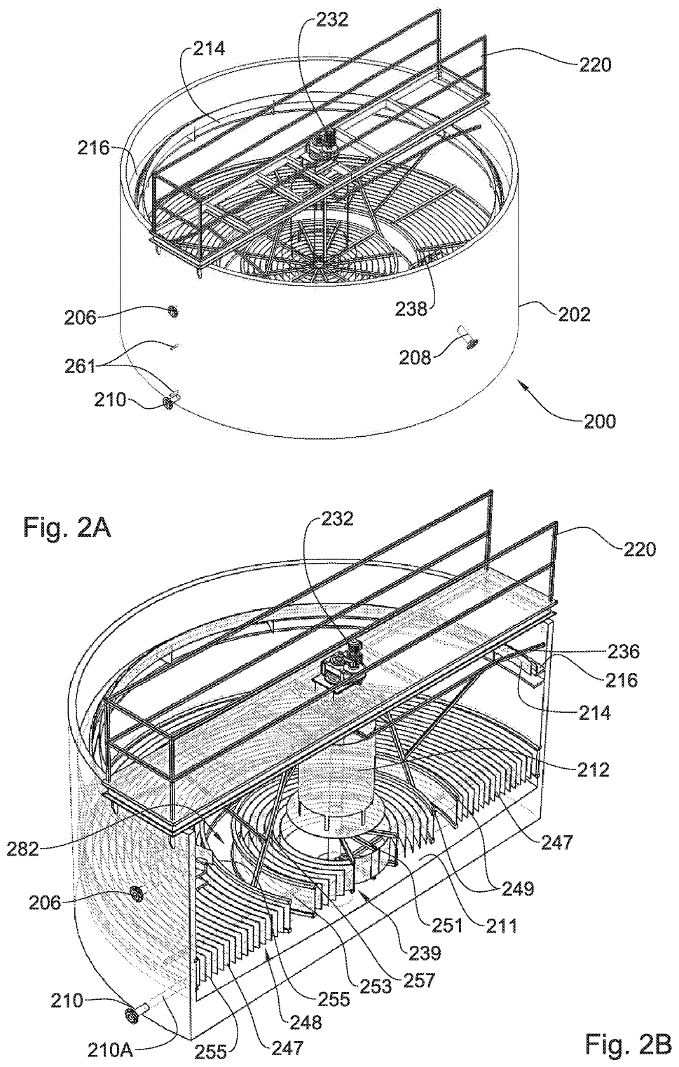

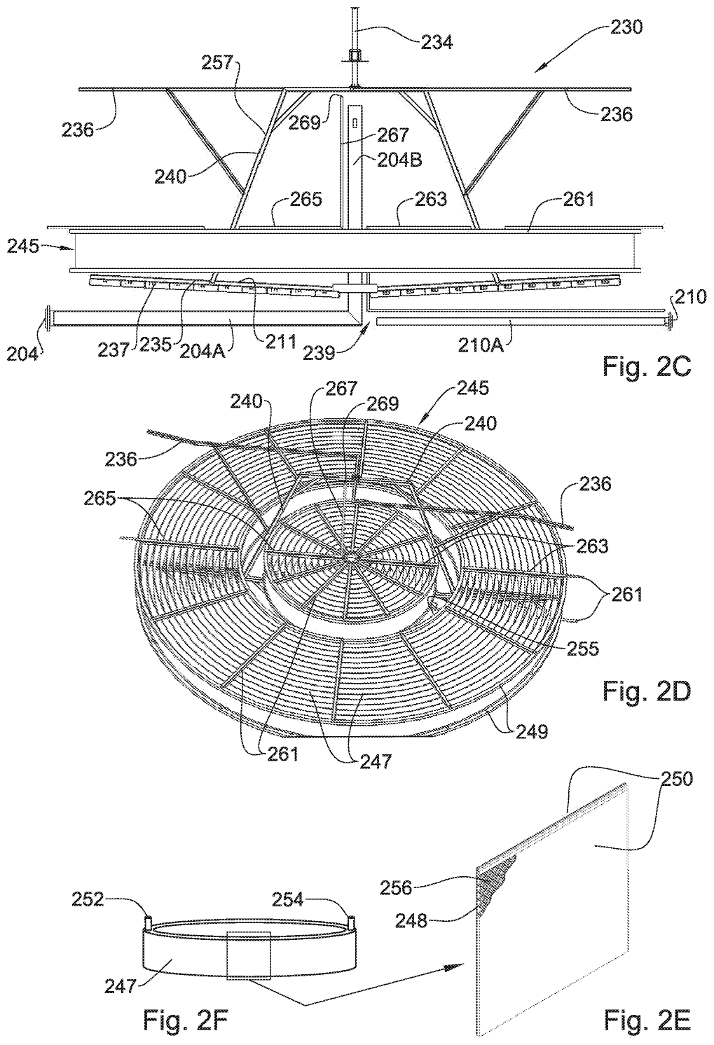

In the other embodiment, illustrated schematically in FIGS. 2A-2F, a plurality of static oxygen supply elements in the form of circular sleeves are used, fixed and confined at the bottom portion of the tank.

As will be appreciated these embodiments are exemplary of the broader scope of the invention as disclosed above, all sharing the general principle of diffusing oxygen to a bottom portion of a clarifier tank, ensuring oxygen supply and hence aerobic conditions so as to degrade organic matter without the undesired generation of gas bubbles, known to cause scum to elevate to upper portions of the tank, thereby reducing the quality of the effluent water.

Concentration of dissolved oxygen of 1 mg/l or more promotes an aerobic bacterial degradation of available biodegradable organic matter, rather than denitrification typically occur under anaerobic conditions; and the oxygen supply assembly is preferably designed to have working parameters intended to achieve such an oxygen concentration in the bottom portion, particularly in the sludge blanket. Such working parameters include, without limitation, the rate of oxygen diffusion out of the membrane, the number of oxygen supply elements, the total surface area of the oxygen permeable membranes, the rate of revolution in the event of revolving plates, etc. During the biological reaction of the biodegradable matter under aerobic conditions, CO₂ is produced which dissolves in water and thus does not form bubbles.

As should appreciated, there can be a large variety of different configurations of the oxygen supply element disclosed herein, which can be revolving or stationary, fixed on more than two radial arms; and there can be other configurations of static oxygen supply element configured as sleeves forming, for example, a plurality of concentric enclosures, each formed in a spiral configuration, etc.

In a clarifier tank, the organic matter settles at the bottom of the tank forming a sludge blanket and most of the organic matter oxidation occurs in that sludge blanket. Therefore, the oxygen supply elements in a unit of this disclosure are preferably placed in or at least partially in the sludge blanket level.

Reference is now made first to FIGS. 1A-1E where the unit includes a revolving array of oxygen supply elements.

The unit 100, generally seen in FIGS. 1A and 1B, has a cylindrical tank 102 with influent inlet port 104 and effluent outlet 106, a scum disposal outlet 108 and sludge outlet 110 at the end of a sludge outlet conduit 110A, the floor 111 at the bottom of the tank may generally be inclined towards the sludge outlet 110. Influent inlet port 104 leads into an inlet conduit with a horizontal section 104A and a vertical section 104B, opening into a feed well compartment 112, from which the influent water spreads within the tank, with liquids flowing mostly upward and solids mostly settle downward. Disposed within the tank is a scum baffle 114 that forms a vertical barrier separating between a central surface area of the water within the tank and a peripheral portion draining into the clarified water trough 116. The central surface area holds the scum, whilst the peripheral portion is fed by clarified water that flows into the peripheral portion from a level lower than that in which the scum accumulates and is, thus, mostly free of scum. The water entering trough 116 drains out through effluent outlet 106.

Formed on top of the tank is a monitoring rack 120 which permits operators to inspect the tank.

The unit also includes a revolving assembly 130, best seen in isolation in FIG. 1C, which revolves horizontally about a vertical axis through the operation of motor 132 coupled to a shaft 134 integral with the revolving assembly.

The revolving assembly includes a frame 140 with two scum scraper, generally radial, arms 136 at its upper end. These arms are positioned above the bottom portion of the scum baffle 114 such that during their revolutions they scrape the upper surface of the water within the tank, thereby scraping and channeling the scum into the scum trough 138 from which the scum is fed into and discharged from scum disposal outlet 108.

Frame 140 includes two radial arms 142 at its bottom end, extending radially outward from annulus 144 that is fitted around tube section 104B. Arms 142 holds a plurality of planar oxygen supply elements 146 which may, by one embodiment be fitted to the arms at an off-tangential angle, as shown in FIG. 1C; or may be arranged tangentially, as shown in FIG. 1D.

Rigid oxygen supply elements in configured as plates fixed to at bottom end of a frame of a revolving assembly, of the kind shown in the exemplary embodiment of FIGS. 1A-1E, may each serve a dual function of an oxygen supply element and that of a scraping blade for scraping sludge off the tank's floor 111. For the scraper function, an angled orientation may be of advantage, since tangentially revolving plates will not permit sludge scraping. Thus, in this manner, the oxygen supply element function and the scraper are in fact integrated and no independent scraper device is needed.

It is also possible to include an additional scarper device with independent scraper blades below the revolving oxygen supply element plates, in which case the oxygen supply element plates may have a tangential orientation, that minimizes water turbulence, as shown in FIG. 1D.

As can be seen, particularly in FIG. 1E, each of the oxygen supply elements 146 has a water-tight enclosure 148 confined between two opposite, water-impermeable and oxygen-permeable membranes 150, a gas inlet 152 and gas outlet 154. Disposed within the enclosure 148 is spacer element 156, which has the form of a grid. It should be noted that the spacer element may have a variety of different forms and a grid structure is just an example. The membranes are typically made of a pliable or flexible material and the spacer element 156 hold the membranes from collapsing one versus the other even when the gas pressure inside the enclosure will be less than that of the surrounding hydrostatic pressure. The gridded spacer element 156 also serves as rigid skeleton and provides for an overall structural support and imparts some robustness to the oxygen supply element. As can be appreciated, the grid of element 156 is configured in a manner to permit flow of gas between gas inlet 152 and gas outlet 154 and distribute it via the various cells defined by the grid through the entire volume of the enclosure.

The oxygen supply elements receive a supply of oxygen-containing gas. A variety of such gases may be contemplated within the framework of this disclosure including pure oxygen, oxygen-enriched gas or air. Air is a specific embodiment and may be of advantage for practical considerations of availability and costs. In the following, the specific embodiments in the annexed drawings will be described with air being the oxygen-containing gas; and it being understood that it is an illustrative description and not a limiting one.

A fan 160 is fixed to the frame by means of a small ramp 182 situated on and fixed to the top of the frame and thus is elevated above the upper level of the water surface within the tank. The fan is electrically wired via a rotating electrical connector (not shown) that permit a constant supply of electricity throughout the revolution of frame 140. Fan 160 is configured to force air into a feed tube 162 that is fixed to and extends downwards along a frame beam to connect to a feed manifold tube 164 (one on each of the arms) fitted along and fixed to arms 142. The manifold tube 164 is linked through small pipes 166 to the gas inlet 152 to thereby channel air into the enclosure of the oxygen supply elements. Gas outlet 154 is linked through small pipes 168 to a drain manifold tube 170 that channel the gas through drain tubes 172 to a venting orifice 174 from which the air is vented into the atmosphere.

The water-impermeable and oxygen-permeable membranes 150 may, by one embodiment consist of a polymeric film or fabric. Such films or fabrics are generally known. The base fabric may be a non-woven polymeric fabric that may, for example, be a dense polyolefin, such as polyethylene or polypropylene or may be a polyester fabric coated by a water-impermeable layer. Such coating is preferably applied to the external water-facing face of the fabric and may have an overall thickness between 5-20 μm. Typically, the water-impermeable and oxygen-permeable membrane is of a known woven fabric formed from a first polymer such as Tyvek® (DuPont) and the second coating polymer may, for example, be alkyl-acrylate. While the first polymeric fabric imparts permeability, the function of the second, coating polymer is intended to substantially seal the fabric to the passage of water, while offering only small resistance to oxygen diffusion therethrough. Alkyl-acrylates are usually the convenient coating in the case of polyolefin fabrics and may be conveniently applied, as noted above, by a variety of coating techniques and extrusion. Where the fabric is made of a polyester, the second polymer coating is suitably poly-methyl-pentene. It should, however, be emphasized that the oxygen supply elements of this disclosure or not limited by a specific type of film or fabric and any film or fabric that may have the combined water impermeability and oxygen permeability may have utility as the oxygen permeable membrane of this disclosure.

The overall required surface area of water-impermeable and oxygen-permeable membranes may be calculated taking into account the following parameters: mixed liquor volatile suspended solids concentration in the wastewater influent; hydraulic retention time in the clarifier; hydrolysis rate; biodegradable organic matter generated by hydrolysis; degradable fraction of the biodegradable organic matter; required biodegradable organic matter removal rate and oxygen permeability properties of the membrane.

For example, according to the calculation shown in the table 1 below, the fraction of volume used to install the membranes is 35% of the clarifier volume. 18 membrane brackets at a size of 1 m² would be installed per each m³ used. The membranes would be spaced apart by a distance of 50.6 mm.

TABLE 1

| # | Parameter | Value | Units |
|---|---|---|---|
| 1 | Mixed Liquor Volatile Suspended | 3000 | mg/l |
| | Solids concentration | | |
| 2 | Hydraulic retention time in | 2 | h |
| | the clarifier | | |
| 3 | Hydrolysis rate | 0.07 | g/g/d |
| 4 | Biodegradable organic matter | 17.5 | mg/l |
| | generated by hydrolysis | | |
| 5 | Degradable fraction | 80% | |
| 6 | Required removal rate | 168.0 | g/d/m³ |
| 7 | Oxygen permeability of membrane | 14 | g/d/m² |

| | | |
|---|---|---|
| Required surface area | 12.0 | m2/m³ |

Example

| | | |
|---|---|---|
| Fraction of volume used | 35% | |
| Number of 1 m² plates per | 18.0 | per m³ used |
| each m3 used | | |
| Spacing between membranes | 50.6 | mm |

Reference is now being made to FIGS. 2A-2F showing, as already noted above, an embodiment with static oxygen supply elements secured at the bottom portion of the tank. Some elements in this embodiment are identical or similar to those shown in FIGS. 1A-1E and accordingly are given the same reference numeral shifted by a hundred. By way of example, tank 202 and scum outlet 208 in FIG. 2A are substantially the same and serve the same function as the respective elements 102 and 108 in FIG. 1A. The reader is referred to the above description for understanding their role or function.

Like the embodiments of FIGS. 1A-1E, the unit of FIGS. 2A-2F comprises a revolving assembly 230 that includes scum scraper arms 236 at the top of frame 240 having the function similar to that of the scum scraper arms 136. Formed at the bottom of frame 240 is a sludge scraper 235 with downwardly extending scraper blades 237. During revolution, sludge accumulates at the bottom of tank 202 toward the central vertex 239 of the conical floor 211 and sludge may then be discharged through conduit 210A and sludge outlet 210.

The stationary oxygen supply element assembly 245 is placed in the sludge blanket level adjacent to and above scraper 235. The assembly 245 comprises an array of concentric oxygen supply elements 247 which are typically held within a frame formed with annular and radial frame elements 249, 251 to the walls or to a central bean of the tank. It should be noted that the concentric array is formed with a clearance 282 between a more central group of oxygen supply elements 253 and a peripheral one 255 that permits passage therethrough and a space for unhindered revolution of beam 257 of frame 240.

FIG. 2E is a schematic illustration of a single circular oxygen supply element 247 having a gas inlet 252 and gas outlet 254 permitting the ingress and egress of supplied air. Portion 2F is shown in enlarged view in FIG. 2F and has functionally a similar structure to that of the oxygen supply element shown in FIG. 1E, particularly in that both comprise two parallel membranes with a spacer element therebetween.

The tank includes also two air feed ports 261 linked to and fed air by fan (not shown). Ports 261 are linked to manifolds 263, which are linked to a feed air into the enclosure of the circular permeable membrane elements 247. Oxygen from the air permeates by diffusion through membranes 250 to thereby support the biological oxidation of biodegradable organic matter in the sludge blanket.

Air outlet manifold 265 is linked to gas outlets 254, draining exhaust gas from within the enclosure 248 of oxygen supply elements 247 to air drain tubes 267, which extend out of the aqueous medium to an orifice 269 above water level or through the tank wall 202, and vented to the atmosphere.

It should be emphasized again that the above description of specific embodiments is illustrative only of the broader scope and teachings of this disclosure and the reader is referred to the general description for a full understanding of the scope of this disclosure.

1.-24. (canceled)

25. A clarifier unit of wastewater treatment system, comprising:
a treatment tank having a bottom wall, side walls, influent inlet, clarified water outlet and a sludge discharge outlet;
wherein
the unit has an oxygen supply assembly, comprising one or more oxygen supply elements confined to a bottom portion of the tank, each of which comprises:
a water-tight enclosure comprising oxygen-permeable membranes permitting oxygen permeation from the enclosure to a surrounding medium, and
a gas inlet for receiving an oxygen-containing gas and a gas outlet for removal of gas.

26. The unit of claim 25, comprising one or both of a scraper adjacent the bottom wall for scraping sludge off the bottom wall and a conveyor for feeding the sludge sediment to the sludge outlet.

27. The unit of claim 26, wherein the one or more oxygen supply elements are situated above a scraper or conveyor situated at the bottom of the tank.

28. The unit of claim 25, wherein the at least one oxygen supply element is positioned such that it is entirely below the clarified water outlet.

29. The unit of claim 25, being a secondary clarifier.

30. The unit of claim 25, wherein the enclosure is defined between two oxygen-permeable membranes.

31. The unit of claim 30, wherein the two oxygen-permeable membranes are essentially parallel to one another.

32. The unit of claim 30, wherein the enclosure comprises one or more spacer elements between the two oxygen-permeable membranes.

33. The unit of claim 30, wherein the oxygen-permeable membranes are essentially vertically oriented.

34. The unit of claim 33, wherein the one or more oxygen supply elements are generally planar elements.

35. The unit of claim 33, wherein the one or more oxygen supply elements are configured as elongated sleeves.

36. The unit of claim 32, wherein the one or more oxygen supply elements define a generally circular path.

37. The unit of claim 36, comprising a plurality of concentric oxygen supply elements.

38. The unit of claim 36, comprising one or more spirally-arranged oxygen supply elements.

39. The unit of claim 25, wherein the oxygen permeable membranes comprise on their external, aqueous-facing face at least one of alkyl-acrylate or poly-methyl-pentene.

40. The unit of claim 25, comprising a plurality of oxygen supply elements configured as plates.

41. The unit of claim 40, wherein the oxygen supply element plates are arranged in an array, in which one or more oxygen supply element plates is oriented parallel to one or more other supply element plates.

42. The unit of claim 40, wherein the oxygen supply element plates have a radial orientation, optionally the oxygen supply element plates are fixed on one or more revolvable radial arms.

43. The unit of claim 40, wherein the one or more oxygen supply element plates are integral with a scraper adjacent the bottom wall for scraping sludge off the bottom wall and a conveyor for feeding the sludge sediment to the sludge outlet.

44. A water treatment system comprising a water treatment unit of claim 25.
